(19) United States
(12) Patent Application Publication
(10) Pub. No.: US 2025/0292930 A1
(43) Pub. Date: Sep. 18, 2025

(54) CONDUCTIVE FILM FOR ATTACHMENT TO ELECTRICAL SYSTEMS

(71) Applicant: 3M INNOVATIVE PROPERTIES COMPANY, St. Paul, MN (US)

(72) Inventor: Larry S. Hebert, Hudson, WI (US)

(21) Appl. No.: 18/860,058

(22) PCT Filed: Apr. 26, 2023
(86) PCT No.: PCT/IB2023/054326

§ 371 Date: Oct. 25, 2024

Related U.S. Application Data
(60) Provisional application No. 63/335,311, filed on Apr. 27, 2022.

(51) Int. Cl. H01B 5/14; B32B 3/26; B32B 7/025; B32B 7/12; B32B 15/04

(52) U.S. Cl. CPC H01B 5/14; B32B 3/266; B32B 7/025; B32B 7/12; B32B 15/04; B32B 2307/202; B32B 2307/7376

(57) ABSTRACT

A film includes a conductive substrate layer having a conductive trace region, a plurality of nonconductive regions, and a plurality of conductive attachment regions. The film may be applied to a nonconductive support and electrically coupled to an electrical pathway of an electrical system. Various techniques for making the film include laser cutting.

The present disclosure relates to electrical conductors and, in particular, electrical conductors attachable to electrical systems of equipment and infrastructure.

Airplanes, wind generators, automobiles, buses, trucks, and other equipment and infrastructure typically include pathways of low electrical resistance to move electrical charge for example, for basic systems operation, antenna grounding, electric field absorption and reflection, and protection from radiated and conducted emissions, electromagnetic interference (EMI), electromagnetic pulse (EMP), and High Intensity Radiated Fields (HIRF). Heavy-gauge bonding jumpers, bus bars, and wiring harnesses have been used to provide such pathways, particularly in conjunction with fiber-reinforced resin matrix materials, which are used in construction of airplanes, wind generators, automobiles, sporting goods, furniture, buses, trucks and other applications where stiff, light-weight materials, or consolidation of parts are beneficial.

### BRIEF SUMMARY

The present disclosure relates to an electrically conductive film usable as a current return path. The film may be structured to facilitate case of attachment to the equipment or infrastructure and ease of protection from corrosion. The film may also be made using manufacturing techniques that facilitate the production of a variety of possible sizes.

In one aspect, a film includes a conductive substrate layer having a major surface extending in at least two dimensions bounded by a periphery, the conductive substrate layer includes a conductive trace region extending along the major surface and having a first density per unit area of the major surface, a plurality of nonconductive regions extending along the major surface, having a second density per unit area of the major surface greater than the first density, and having an average nonconductive region area, each nonconductive region being surrounded by a portion of the conductive trace region, a plurality of conductive attachment regions extending along the major surface, each conductive attachment region having an associated conductive attachment region area greater than or equal to the average nonconductive region area.

In another aspect, an apparatus includes an electrical system having an electrical pathway, a nonconductive support, and a film according to the present disclosure applied to the nonconductive support and electrically coupled to the electrical pathway.

In another aspect, a method of making a film includes providing a conductive substrate layer having a major surface extending in at least two dimensions bounded by a periphery. The method also includes forming regions in a conductive foil to provide a conductive substrate layer. The conductive substrate layer includes a conductive trace region extending along the major surface and having a first density per unit area of the major surface, a plurality of nonconductive regions extending along the major surface, having a second density per unit area of the major surface greater than the first density, and having an average nonconductive region area, each nonconductive region being surrounded by a portion of the conductive trace region, and a plurality of conductive attachment regions extending along the major surface, each conductive attachment region having an associated conductive attachment region area greater than or equal to the average nonconductive region area. The method also includes laminating an adhesive layer to the conductive substrate layer.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an apparatus including a film in accordance with one embodiment.

FIG. 2 illustrates a film usable in the apparatus of FIG. 1 in accordance with one embodiment.

### DETAILED DESCRIPTION

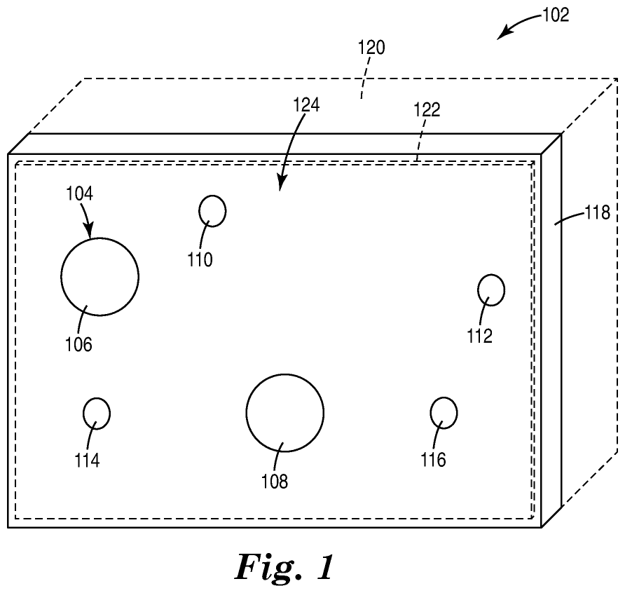

FIG. 1 is a schematic view of an apparatus 102 including a film 122 in accordance with one embodiment. The apparatus 102 may be any component, equipment, or infrastructure, such as an airplane, wind generator, automobile, bus, truck, or other equipment. The apparatus 102 includes a nonconductive support 118, a film 122 applied to the nonconductive support, and an electrical system 120 coupled to the nonconductive support 118. The film 122 may be applied to a side of the nonconductive support 118 opposite the electrical system 120.

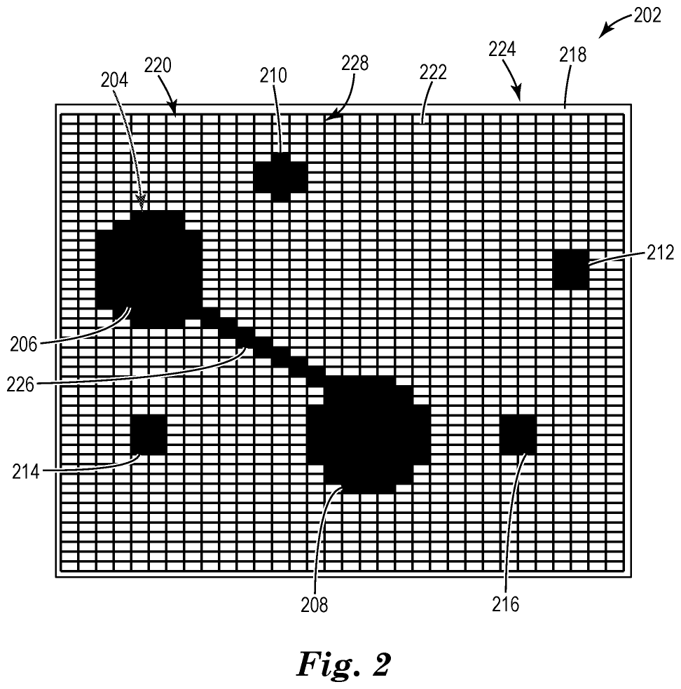

The film 122 may cover at least some, or all, of a surface of the nonconductive support 118. In general, the film 122 is configured to provide a current path, such as a current return path, for the electrical system 120. The film 122 is at least partially, or entirely, conductive to facilitate current flow. In some embodiments, the film 122 includes a conductive substrate layer 202 (see FIG. 2).

The film 122 has a major surface 124. The major surface 124 extends in at least two dimensions (2D or 3D) and is bounded by a periphery. The major surface 124 may be substantially planar (2D) or may be curved (3D) before, during, or after application. In some embodiments, the film 122 is conformable to the major surface of the nonconductive support 118 when applied, which may be substantially planar (2D) or may be curved (3D).

“Major surface” refers to a relatively large surface of a structure. For film-like or layer structures, a major surface may be described as a first major surface and the structure generally has a second major surface opposite the first major surface.

The film 122 may be applied to the nonconductive support 118 in any suitable manner. In some embodiments, the apparatus 102 includes an adhesive layer (not shown) to bond the conductive substrate layer 202 to the nonconductive support 118. The adhesive layer may include an adhesive resin. The adhesive resin may be a thermosetting or pressure sensitive adhesive. Non-limiting examples of adhesive resin include epoxy and acrylic (e.g., rubber).

The nonconductive support 118 is a nonconductive structure of the component, equipment, or infrastructure. The nonconductive support 118 may be formed from any suitable nonconductive material, which may include a composite material. In some embodiments, the nonconductive support 118 is a fiber-reinforced resin matrix composite material. The fibers may be made of carbon, glass, ceramic, or aramid. The resin may be made of an organic thermosetting material. In some embodiments, the nonconductive support 118 may be formed of a thermoplastic material.

A “conductive” component may include electrical conductors or electrical semiconductors as materials. A “nonconductive” component may include electrical insulators or electrical semiconductors as materials. As used herein, any “conductive” component has a conductivity value greater than any “nonconductive” component. In some embodiments, a ratio of a first conductivity value of a conductive material (e.g., for some or all conductive regions) to a second conductivity value of a nonconductive material (e.g., for some or all nonconductive regions) is greater than or equal to 10²⁰, 10¹⁵, 10¹⁰, 10⁵, or even 10. Conductive and nonconductive materials may be selected based on desired functionality.

The apparatus 102 may include one or more attachment sites 104. Each of the attachment sites 104 is conductive and provides an electrical pathway from one side of the nonconductive support 118 to its opposite side. In some embodiments, each of the attachment sites 104 provides an independent, or separate, electrical pathway through the nonconductive support 118. Each of the attachment sites 104 is configured to electrically couple one or more electrical pathways of the electrical system 120 to the film 122.

The electrical system 120 has at least one electrical pathway (not shown). In some embodiments, one or more of the electrical pathways is a conductor of the electrical system 120, such as a current return pathway. When assembled, the conductive substrate layer 202 of the film 122 is electrically coupled to the attachment sites 104, and the attachment sites 104 are connected to one or more electrical pathways of the electrical system 120.

The attachment sites 104 may have any suitable size or shape to facilitate functioning as an electrical connection. As illustrated, the apparatus 102 includes multiple attachment sites 104 with two different sizes. Each size may be used with one or more attachment sites. The attachment sites 104 include first attachment sites 106, 108 having a first size and second attachment sites 110, 112, 114, 116 having a second size smaller than the first size.

“Size” refers to a surface area of a component along its major surface. For example, each of the attachment sites 104 has a surface area, or size, extending along the major surface of the nonconductive support 118.

FIG. 2 is a plan view of a conductive substrate layer 202 that may be used with the film 122 (FIG. 1). The conductive substrate layer 202 includes one or more features to facilitate its functionality as an electrical conductor, such as a current return path in a circuit. In general, the conductive substrate layer 202 includes a conductive trace region 222, a plurality of nonconductive regions 220, a plurality of conductive attachment regions 204, a periphery 224, and optionally one or more conductive connection regions 226.

The conductive substrate layer 202 may be formed from any suitable conductive material, such as one or more metals. For example, the conductive substrate layer 202 may be at least partially, or entirely, made of copper or aluminum. The nonconductive support 118 has a conductivity value less than the conductive substrate layer 202 of the film 122.

The conductive substrate layer 202 may have any suitable thickness as part of the film. In some embodiments, the conductive substrate layer 202 has a thickness greater than or equal to 9 micrometers. In some embodiments, the conductive substrate layer 202 has a thickness less than or equal to 210 micrometers.

The conductive trace region 222 extends along the major surface 228 of the conductive substrate layer 202. The major surface 228 of the conductive substrate layer 202 may be coextensive with the major surface 124 (FIG. 1) of the film 122 (FIG. 1).

The nonconductive regions 220 collectively extend along the major surface 228 of the conductive substrate layer 202. Each of the nonconductive regions 220 is surrounded by a portion of the conductive trace region 222 along the major surface 228. The nonconductive regions 220 may be formed by any suitable nonconductive material. In some embodiments, each of the nonconductive regions 220 are formed as an opening in the conductive substrate layer 202, which may be filled by air, an adhesive layer described with respect to FIG. 1, or other nonconductive filler.

The nonconductive regions 220 collectively define, or have, an average nonconductive region area. “Average nonconductive region area” refers to the sum of nonconductive region areas along a corresponding major surface divided by the number of nonconductive regions. For example, when the nonconductive regions 220 are openings in the conductive substrate layer 202, the corresponding major surface is the major surface 228 of the conductive substrate layer 202.

The nonconductive regions 220 may have any suitable area, or size. The area may be defined by the dimensions of the adjacent, or surrounding, conductive trace region. The areas may be uniform or non-uniform. “Uniform area” refers to each area being within #10% of each other.

The nonconductive regions 220 may have any suitable shape. Non-limiting examples of shapes include one or more of the following shapes: rectangular, quadrilateral, hexagonal, circular, ovate, and triangle, including rounded or elongated versions thereof.

The arrangement of conductive trace regions 222 and nonconductive regions 220 may form a pattern. One non-limiting example of a pattern is a matrix-like pattern, or array, as shown in the illustrated embodiment or, for example, having the shapes described with respect to nonconductive regions 220.

The conductive trace region 222 may have a first density per unit area of the major surface 228. The nonconductive regions 220 may have a second density per unit area of the major surface 228. In some embodiments, the second density may be greater than the first density as shown in the illustrated embodiment. “Density” refers to the sum of a respective region area divided by a total area (e.g., area of the full conductive layer or film). In some embodiments, the first density is greater than or equal to 10 per unit area and less than or equal to 30 per unit area. In some embodiments, the second density is greater than or equal to 70 per unit area and less than or equal to 90 per unit area.

The conductive attachment regions 204 extend along the major surface 228. In general, the conductive attachment regions 204 are sized and positioned to interface with the attachment sites 104 (FIG. 1) of the apparatus 102 (FIG. 1). The conductive attachment regions 204 may be formed of any suitable material. In some embodiments, the conductive attachment regions 204 are formed of the same material as the conductive trace region 222.

Each of the conductive attachment regions 204 has an associated conductive attachment region area. In general, the conductive attachment region areas are greater in size than the nonconductive region areas. In some embodiments, each conductive attachment region area is greater than or equal to the average nonconductive region area.

The conductive attachment region areas may be the same or different for each of the conductive attachment regions 204. In some embodiments, each conductive attachment region area is larger than the average nonconductive region area. In one example, each of the in conductive attachment regions 204 may be formed by not providing an opening in two or more areas where there would be one of the nonconductive regions 220 in a pattern.

Each conductive attachment region area may be an integer multiple of the average nonconductive region area. Non-limiting examples of integer multiples include being greater than or equal to 2, 3, 4, 5, 6, or even 8.

The periphery 224 may be formed at least partially, or entirely, by the peripheral region 218. The peripheral region 218 may provide a border at least partially, or entirely, surrounding some or all of the conductive trace region 222, the nonconductive regions 220, and the conductive attachment regions 204.

The film may also include where the conductive substrate layer further includes one or more conductive connection regions extending along the major surface each adjacent to at least one of the conductive attachment region, each conductive connection region having an associated conductive connection region area greater than or equal to the average nonconductive region area.

The conductive connection regions 226 extend along the major surface 228. In general, conductive connection regions 226 are configured to electrically couple to conductive attachment regions 204 to provide an electrical pathway with higher conductance than a similar length of conductive trace region 222. The conductive connection regions 226 may be described as having a greater width than a similar portion of the conductive trace region 222.

The conductive trace region 222 may be described as having a plurality of conductive traces. Each of the conductive traces are electrically coupled to at least one other conductive trace. The conductive traces may collectively define, or have, an average conductive trace width. Non-limiting examples of the average conductive trace width include being less than or equal to 5, 3, 2, 1, or even 0.5 millimeters. The width of conductive traces may be selected, for example, based on a desired resistance between conductive attachment regions 204.

Each conductive connection region 226 is positioned adjacent to at least one of the conductive attachment regions 204. In some embodiments, each conductive connection region 226 is positioned adjacent to at least two conductive attachment region 204 to provide an electrical pathway between them.

Each conductive connection region 226 may have any suitable size and position to provide the appropriate electrical properties to the film. In some embodiments, each conductive connection region 226 has an associated conductive connection region area greater than or equal to the average nonconductive region area. For example, each of the conductive connection region 226 may be formed by not providing an opening in one or more areas where there would be one of the nonconductive regions 220 in a pattern.

In some embodiments, some or all of the conductive substrate layer 202 may at least partially form a single electrical node. For example, two or more of the conductive trace region 222, the conductive attachment regions 204, and the conductive connection region 226 may form part of the same electrical node.

The conductive substrate layer 202 of the film may be made in any suitable manner. In some embodiments, a laser cutting process may be used to form openings in a conductive foil or otherwise perforating the conductive foil. The openings may be used as nonconductive regions. Unperforated portions may be used as conductive attachment regions and conductive connection regions. Such a technique may be used to provide various shapes and various orientations, in repetitive or non-repetitive patterns, or combinations thereof. The pattern may be designed to provide one or more current paths between attachment sites and provide a structurally self-stabilizing conductive substrate layer 202 for ease of handling. Such a layer may be embedded in other materials, laminated with other layers, or applied with an adhesive. For example, an adhesive layer may be laminated to the conductive substrate layer 202. The adhesive layer may include an adhesive resin.

In one example, a copper foil may be laser cut to form hexagonal holes in a pattern while leaving some areas unperforated to form conductive attachment regions in a conductive substrate layer. The conductive attachment regions may be masked with a polyester tape pieces on one side of the conductive substrate layer. An epoxy coated release liner may be applied to the first major surface of the conductive substrate layer. The second major surface may be laminated to a carbon fiber reinforced plastic panel under vacuum. The polyester tape pieces may be removed to expose the foil at the conductive attachment regions.

Thus, various embodiments of a CONDUCTIVE FILM FOR ATTACHMENT TO ELECTRICAL SYSTEMS are disclosed. Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

1. A film comprising:
a conductive substrate layer having a major surface extending in at least two dimensions bounded by a periphery, the conductive substrate layer comprising:
a conductive trace region extending along the major surface and having a first density per unit area of the major surface;
a plurality of nonconductive regions extending along the major surface, having a second density per unit area of the major surface greater than the first density, and having an average nonconductive region area, each nonconductive region being surrounded by a portion of the conductive trace region;
a plurality of conductive attachment regions extending along the major surface, each conductive attachment region having an associated conductive attachment region area greater than or equal to the average nonconductive region area.

2. The film of claim 1, wherein each nonconductive region is an opening in the conductive substrate layer.

3. The film of claim 1, wherein the nonconductive regions have uniform areas within ±10% of each other.

4. The film of claim 1, wherein each conductive attachment region area is larger than the average nonconductive region area.

5. The film of claim 4, wherein each conductive attachment region area is any integer multiple greater than or equal to 2 of the average nonconductive region area.

6. The film of claim 1, wherein the conductive substrate layer further comprises one or more conductive connection regions extending along the major surface each adjacent to at least one of the conductive attachment regions, each conductive connection region having an associated conductive connection region area greater than or equal to the average nonconductive region area.

7. The film of claim 1, wherein the conductive trace region and the plurality of nonconductive regions form a matrix-like pattern and each nonconductive region has one or more of the following shapes: rectangular, quadrilateral, hexagonal, circular, ovate, and triangle, including rounded or elongated versions thereof.

8. The film of claim 1, wherein the conductive substrate layer further comprises a peripheral region at least partially forming the periphery.

9. The film of claim 1, wherein the conductive trace region and conductive attachment region at least partially form a single electrical node.

10. The film of claim 1, wherein the conductive trace region comprises a plurality of conductive traces having an average conductive trace width less than or equal to 5 millimeters, each conductive trace being electrically coupled to at least one other conductive trace.

11. The film of claim 1, wherein the conductive substrate layer has a thickness between 9 micrometers and 210 micrometers.

12. The film of claim 1, wherein a ratio of a first conductivity value of a first material forming the conductive trace region to a second conductivity value of a second material forming the nonconductive regions is greater than or equal to 10.

13. An apparatus comprising:
an electrical system having an electrical pathway;
a nonconductive support; and
the film according to claim 1 applied to the nonconductive support and electrically coupled to the electrical pathway.

14. A method of making a film comprising:
providing a conductive substrate layer having a major surface extending in at least two dimensions bounded by a periphery;
forming regions in a conductive foil to provide a conductive substrate layer comprising:
a conductive trace region extending along the major surface and having a first density per unit area of the major surface,
a plurality of nonconductive regions extending along the major surface, having a second density per unit area of the major surface greater than the first density, and having an average nonconductive region area, each nonconductive region being surrounded by a portion of the conductive trace region, and
a plurality of conductive attachment regions extending along the major surface, each conductive attachment region having an associated conductive attachment region area greater than or equal to the average nonconductive region area; and
laminating an adhesive layer to the conductive substrate layer.

15. The method of claim 14, wherein forming regions in the conductive foil comprises laser cutting the conductive foil.
